(19) United States
(12) Patent Application Publication
(10) Pub. No.: US 2015/0169406 A1
(43) Pub. Date: Jun. 18, 2015

(54) DECODING TECHNIQUES FOR A DATA STORAGE DEVICE

(71) Applicant: SANDISK TECHNOLOGIES INC., Plano, TX (US)

(72) Inventors: ZONGWANG LI, DUBLIN, CA (US); MANUEL ANTONIO D'ABREU, EL DORADO HILLS, CA (US)

(73) Assignee: SANDISK TECHNOLOGIES INC., PLANO, TX (US)

(21) Appl. No.: 14/107,973

(22) Filed: Dec. 16, 2013

(51) Int. Cl. G06F 11/10

(52) U.S. Cl. CPC G06F 11/1076

(57) ABSTRACT

A data storage device includes a buffer and a decoder. The buffer is configured to receive a set of bits representing data stored at a memory. The decoder is configured to receive the set of bits from the buffer. The decoder is further configured to perform a decoding operation based on the set of bits at a decoding throughput that corresponds to a storage size of the buffer.

### FIELD OF THE DISCLOSURE

The present disclosure is generally related to decoding techniques for a data storage device.

### BACKGROUND

Nonvolatile data storage devices, such as embedded memory devices and removable memory devices, enable portability of data and software applications. In certain flash memory devices, multi-level cell (MLC) storage elements may each store a threshold voltage representing multiple bits of data, enhancing data storage density as compared to single-level cell (SLC) flash memory devices. The enhanced storage density may be associated with increased data errors, such as bit corruption.

To correct data errors, a flash memory device may utilize an error correcting code (ECC) technique. To illustrate, the flash memory device may encode user data using an ECC technique to generate encoded data, such as an ECC codeword. The encoded data may be stored at the flash memory device and may be decoded by the flash memory device upon accessing the data.

ECC decoding techniques include “hard” decoding schemes and “soft” decoding schemes. A hard decoding scheme typically senses “hard” bit values, such as “0” bits and “1” bits, and decodes the hard bit values to generate user data. A soft decoding scheme may utilize bit reliability information (or “soft” bits) indicating a likelihood that bits of data are “correct.” For example, if a threshold voltage stored at a storage element of the flash memory device is approximately centered in a target threshold voltage range associated with a “0” bit, then a soft bit may have a value indicating that a bit value associated with the storage element is reliably a “0” bit. As another example, if the threshold voltage is near a boundary (or outside) of the target threshold range, then the soft bit may have a value indicating that a bit value associated with the storage element cannot be (or has not been) determined reliably.

### SUMMARY

Power management and processing efficiency of a data storage device may be improved by utilizing multiple decoders to decode data accessed from a memory. The multiple decoders may include a first decoder, such as a “high resolution” decoder, and a second decoder, such as a “low cost” or “low resolution” decoder. In a particular example, the first decoder is a “soft” decision decoder that is responsive to soft bits. The second decoder may be a “hard” decision decoder that is responsive to hard bits.

The multiple decoders may operate cooperatively to achieve a low power consumption associated with the second decoder while also enabling high error correction capabilities that are associated with the first decoder. To illustrate, in response to initiating a decoding operation of an error correcting code (ECC) codeword accessed from the memory, the data storage device may “default” the decoding operation to the second decoder. Because most ECC codewords are expected statistically to have an error rate that is within an error correction capability of the second decoder, the decoding operation is statistically likely to succeed. If the error rate of the ECC codeword exceeds the error correction capability of the second decoder (and the second decoder fails to successfully decode the ECC codeword), the ECC codeword and a set of soft bits associated with the ECC codeword may be provided to the first decoder. The first decoder may have a higher error correction capability than the second decoder and may be likely to decode the ECC codeword successfully.

Because most ECC codewords can be decoded by the second decoder, a decoding throughput of the first decoder may be less than a full decoding throughput at which the first decoder can operate. That is, because the second decoder is statistically likely to decode most ECC codewords accessed from the memory, the first decoder need not operate at a decoding throughput that would enable the first decoder to decode each of the ECC codewords. Accordingly, operation of the first decoder may be slowed, conserving power at the data storage device.

The decoding throughput of the first decoder may correspond to a storage size of a buffer that buffers data to be decoded by the multiple decoders. For example, the decoding throughput may be selected to enable the first decoder to decode a sufficient number of ECC codewords such that overflow does not occur at the buffer. To illustrate, if the decoding throughput is too low relative to the storage size of the buffer, then the first decoder may be unable to decode an ECC codeword by the time another ECC codeword is input to the buffer, which may cause overflow at the buffer. Further, poor power management may result if the decoding throughput is too high relative to the storage size, since ECC codewords may be decoded faster than a rate at which ECC codewords can be accessed from the memory and input to the buffer. Accordingly, the decoding throughput may be selected based on a storage size of the buffer.

Selecting the decoding throughput of the first decoder as described may improve power management and processing efficiency of a data storage device. For example, a device that utilizes a “low cost” decoder to decode data may consume a small amount of power, but the device may have limited error correction capability. A device that utilizes a “high resolution” decoder to decode data may have increased error correction capabilities, but operation of the high resolution decoder may result in increased power consumption. A data storage device in accordance with the present disclosure may utilize multiple decoders to achieve the performance of one decoder (e.g., a high resolution decoder) while also operating at the power efficiency of another decoder (e.g., a low resolution decoder), resulting in improved power management and processing efficiency at the data storage device.

### BRIEF DESCRIPTION OF THE DRAWINGS

FIG. 1 is a diagram of a particular illustrative embodiment of a system that includes a data storage device;

FIG. 2 is a flow diagram of a particular illustrative embodiment of a method of operating the data storage device of FIG. 1;

FIG. 3 is a flow diagram of another particular illustrative embodiment of a method of operating the data storage device of FIG. 1;

FIG. 4 is a flow diagram of a particular illustrative embodiment of a method of determining a decoding throughput of a decoder of the data storage device of FIG. 1; and

FIG. 5 is a diagram of a particular illustrative embodiment of a decoder that may be included in the data storage device of FIG. 1.

### DETAILED DESCRIPTION

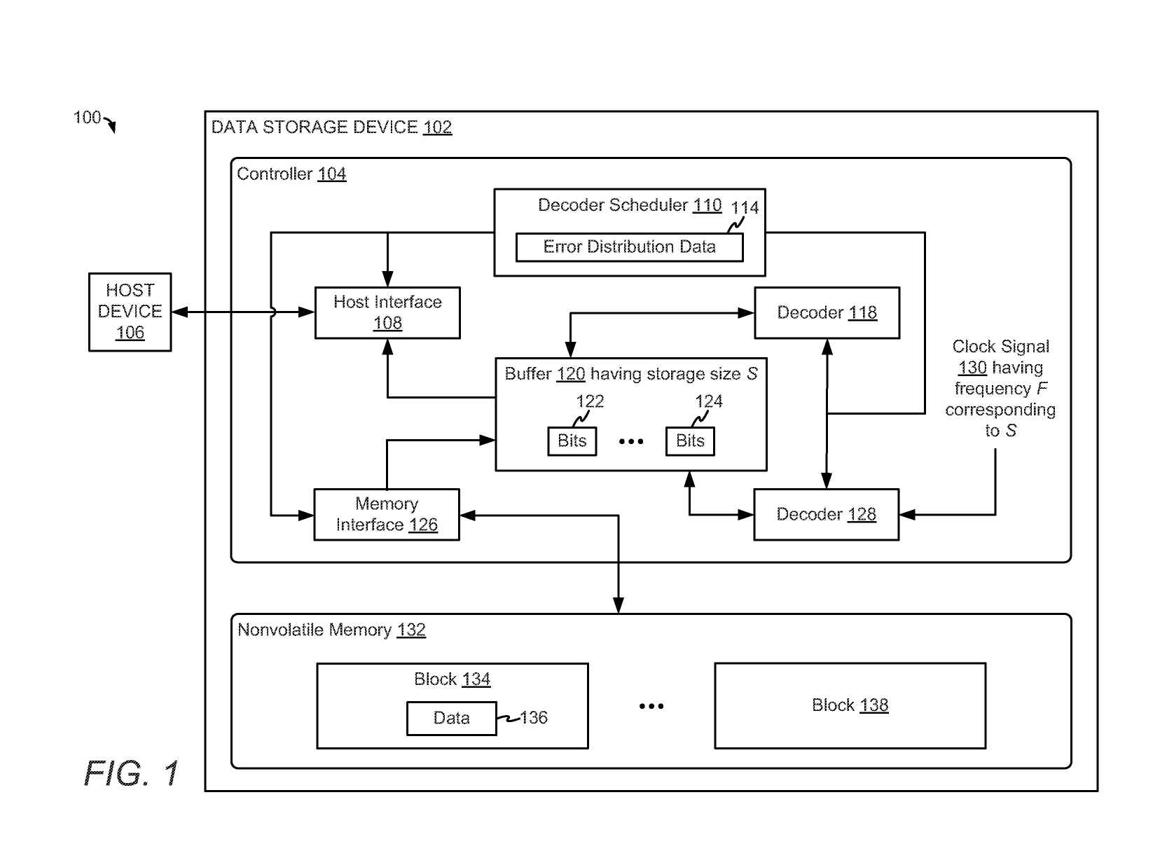

Referring to FIG. 1, a particular illustrative embodiment of a system is depicted and generally designated 100. The system 100 includes a data storage device 102 and a host device 106. The data storage device 102 may be embedded within the host device 106, such as in accordance with a Joint Electron Devices Engineering Council (JEDEC) Solid State Technology Association Universal Flash Storage (UFS) configuration. Alternatively, the data storage device 102 may be removable from the host device 106 (e.g., “removably” coupled to the host device 106). As an example, the data storage device 102 may be removably coupled to the host device 106 in accordance with a removable universal serial bus (USB) configuration.

The data storage device 102 may include a controller 104 and a memory, such as a nonvolatile memory 132. The controller 104 may include a host interface 108, a decoder scheduler 110, a decoder 118, a buffer 120, a memory interface 126, and a decoder 128. The decoder 128 may be responsive to a clock signal 130. The clock signal 130 may have a frequency F, and the buffer 120 may have a storage size S. The nonvolatile memory 132 may include multiple blocks, such as a block 134 and a block 138. In a particular embodiment, the buffer 120 is a buffer random access memory (BRAM). In a particular embodiment, the decoder 118 has one or more different characteristics than the decoder 128, such as one or more of a smaller circuit area than the decoder 128, a lower cost than the decoder 128, a faster decoding performance than the decoder 128, or a lower power consumption than the decoder 128. For example, the decoder 118 may correspond to an “on-the-fly” (OTF) decoder, and the decoder 128 may correspond to a “full-blown” decoder.

The controller 104 is configured to receive data and instructions from the host device 106 and to send data to the host device 106. For example, the controller 104 may send data to the host device 106 via the host interface 108 and may receive data from the host device 106 via the host interface 108.

The controller 104 may include an encoder (not shown in FIG. 1) that is configured to receive data and to generate one or more error correcting code (ECC) codewords based on the data. For example, the encoder may be configured to encode data using an ECC encoding technique. The encoder may include a Hamming encoder, a Reed-Solomon (RS) encoder, a Bose-Chaudhuri-Hocquenghem (BCH) encoder, a low-density parity check (LDPC) encoder, a turbo encoder, an encoder configured to encode data according to one or more other ECC techniques, or a combination thereof.

The controller 104 is configured to send data and commands to the nonvolatile memory 132 and to receive data from the nonvolatile memory 132. For example, the controller 104 is configured to send data and a write command via the memory interface 126 to cause the nonvolatile memory 132 to store the data to a specified address of the nonvolatile memory 132. As a particular example, the controller 104 may send data 136 and a write command to the nonvolatile memory 132. The write command may specify a physical address of a portion of the nonvolatile memory 132 (e.g., a physical address of a word line of the block 134) that is to store the data 136. The data 136 may correspond to one or more ECC codewords generated by an encoder of the controller 104 (not shown in FIG. 1).

The controller 104 is configured to send a read command via the memory interface 126 to access data from a specified address of the nonvolatile memory 132. As an example, the controller 104 may send a read command to access the data 136. The read command may specify a physical address of a portion of the nonvolatile memory 132 (e.g., a physical address of a word line of the block 134) storing the data 136.

The decoders 118, 128 may be configured to decode data accessed from the nonvolatile memory 132. To illustrate, the data 136 may be (or may include) one or more ECC codewords that can be decoded by the decoders 118, 128. The decoders 118, 128 may be configured to decode data read from the nonvolatile memory 132 to detect and correct one or more bit errors that may be present in the read data. Bit errors may occur in the data 136 while writing the data 136 (e.g., due to over-programming or under-programming storage elements of the nonvolatile memory 132), during storage of the data 136 (e.g., due to charge leakage), and/or while accessing the data 136 (e.g., due to noise or other factors).

In operation, the data storage device 102 may access the data 136. For example, the data storage device 102 may receive a request for read access to the data 136 from the host device 106 via the host interface 108. The controller 104 may send a command to the nonvolatile memory 132 to read the data 136. The nonvolatile memory 132 may access the data 136 to generate a set of bits 122 in response to the command. The set of bits 122 may correspond to an ECC codeword that represents the data 136.

The command may specify a type of data access requested by the controller 104. For example, the command may specify a “hard” data access technique, and the nonvolatile memory 132 may access the data 136 using the hard data access technique to generate a set of hard bits each having a “0” value or a “1” value. In this example, the set of bits 122 includes a set of hard bits. The nonvolatile memory 132 may send the set of bits 122 to the controller 104 via the memory interface 126. The controller 104 may store (e.g., buffer) the set of bits 122 at the buffer 120, as illustrated in the example of FIG. 1.

The set of bits 122 may represent an ECC codeword that is encoded using one or more ECC techniques. The one or more ECC techniques may include a Hamming encoding technique, an RS encoding technique, a BCH encoding technique, an LDPC encoding technique, a turbo encoding technique, a product code encoding technique, and/or another encoding technique. To decode the data 136, the controller 104 may initiate a decoding operation. For example, the controller 104 may initiate a decoding operation at the decoder 118. In a particular embodiment, the decoder 118 is configured to attempt to decode the set of bits 122 using a Berlekamp-Massey (BM) decoding technique. The decoder 118 may attempt to reach a “hard” decoding decision based on the set of bits 122. The decoder 118 may be a “low power” (or “low resolution”) decoder, which may perform decoding operations faster than the decoder 128. For example, the decoder 118 may be responsive to a clock signal having a higher frequency than the frequency F of the clock signal 130.

If the decoder 118 successfully decodes the set of bits 122 (e.g., by correcting one or more bit errors that may be present in the set of bits 122), the decoder 118 may output data corresponding to the data 136. The data may be buffered at the buffer 120 and may be provided to the host device 106 via the host interface 108.

If the decoder 118 does not successfully decode the set of bits 122 (e.g., due to a number of bit errors of the set of bits 122 exceeding an error correction capability of the decoder 118), the controller 104 may initiate a decoding operation at the decoder 128. In a particular embodiment, the controller 104 may send a command to the nonvolatile memory 132 to re-access the data 136 in response to the decoder 118 failing to successfully decode the set of bits 122. The nonvolatile memory 132 may re-access the data 136 to generate a set of bits 124 in response to the command. The command may specify a type of data access requested by the controller 104. For example, the command may specify a “soft” data access technique, and the nonvolatile memory 132 may access the data 136 using the soft data access technique to generate a set of soft bits. In this example, the set of bits 124 includes a set of soft bits. In a particular embodiment, the set of bits 124 is a set of soft bits each indicating a likelihood (or confidence) that a respective bit value of the set of bits 122 is “correct.” The nonvolatile memory 132 may send the set of bits 124 to the controller 104 via the memory interface 126. The controller 104 may store (e.g., buffer) the set of bits 124 at the buffer 120, as illustrated in the example of FIG. 1.

The decoder 128 may perform a decoding operation using the set of bits 122 and the set of bits 124. For example, the decoder 128 may attempt to reach a “soft” decoding decision using the set of bits 122 and the set of bits 124. In a particular embodiment, the decoder 128 is a “high resolution” decoder having a high error correction capability (e.g., an error correction capability higher than that of the decoder 118). If the decoder 128 successfully decodes the set of bits 122 using the set of bits 124 (e.g., by correcting one or more bit errors that may be present in the set of bits 122 using the set of bits 124), the decoder 128 may output data corresponding to the data 136. The data may be buffered at the buffer 120 and provided to the host device 106 via the host interface 108.

The decoder 128 may perform one or more decoding operations at a decoding throughput T1. For example, the one or more decoding operations may be performed by the decoder 128 at an average rate that is sufficient to achieve the decoding throughput T1. In the example of FIG. 1, the decoding throughput T1 corresponds to the storage size S of the buffer 120. As used herein, the decoding throughput T1 may correspond to the storage size S if the decoding throughput T1 is selected based on the storage size S, if the storage size S is selected based on the decoding throughput T1, and/or if the storage size S and the decoding throughput T1 are selected based on one or more common parameters. The one or more common parameters may include an expected error distribution D of ECC codewords accessed from the nonvolatile memory 132, a decoding throughput T2 of the decoder 118, and/or a system throughput T to be achieved at the data storage device 102, as illustrative examples.

To illustrate, in the particular example of FIG. 1, the frequency F of the clock signal 130 corresponds to the storage size S of the buffer 120. For example, the frequency F and/or the storage size S may be selected such that the decoding throughput T1 of the decoder 128 is operable to decode a sufficient number of ECC codewords at a rate such that overflow does not occur at the buffer 120. To further illustrate, if the frequency F is too low relative to the storage size S, then the decoder 128 may be unable to decode an ECC codeword by the time another ECC codeword is input to the buffer 120, which may cause overflow at the buffer 120. Further, increased power consumption may result if the frequency F is too great relative to the storage size S, since the decoder 128 may decode ECC codewords faster than a rate at which ECC codewords can be input to the buffer 120. Accordingly, the frequency F may be selected based on the storage size S. Alternatively, the storage size S may be selected based on the frequency F. The frequency F may be less than a capacity frequency (or “highest” frequency) at which the decoder 128 can operate. The decoding throughput T1 may be determined by selecting the frequency F. For example, for a higher frequency F, more decoding operations may be performed for a particular time duration as compared to a lower frequency F, resulting in a higher decoding throughput T1.

Alternatively or in addition, the frequency F and/or the storage size S may be selected based on the expected error distribution D of ECC codewords accessed from the nonvolatile memory 132. For example, if every nth ECC codeword is statistically expected to have an error rate that exceeds the error correction capability of the decoder 118, then the frequency F and/or the storage size S may be selected such that the decoder 128 is operable to decode every nth ECC codeword that is buffered at the buffer 120. In a particular embodiment, the frequency F and/or the storage size S is selected to achieve a decoding throughput T1 to enable the decoder 128 to decode ECC codewords for p percent of data accesses at the nonvolatile memory 132 and to enable the decoder 118 to decode ECC codewords for (100-p) percent of data accesses at the nonvolatile memory 132.

The parameter p can be determined using a statistical technique, such as a statistical model associated with a memory type corresponding to the nonvolatile memory 132. To illustrate, a multi-level cell (MLC) configuration may be associated with a first expected error distribution, and a single-level cell (SLC) configuration may be associated with a second expected error distribution. The MLC configuration may be associated with a first Gaussian distribution of threshold voltages having a first mean and a first standard deviation, and the SLC configuration may be associated with a second Gaussian distribution of threshold voltages having a second mean and a second standard deviation. As another example, an encoding technique used by the controller 104 may be associated with a particular Gaussian distribution of threshold voltages having a third mean and a third standard deviation. Mean values and standard deviation values can be used to generate a statistical model associated with a particular configuration of the data storage device 102, such as by predicting a number of bit errors that may occur based on one or more mean values and one or more standard deviation values. The frequency F may be increased for a greater number of predicted bit errors, and the frequency F may be decreased for a lesser number of predicted bit errors.

Further, certain types of storage elements of the nonvolatile memory 132 may be expected to exhibit particular “wear” characteristics. As a particular example, transistors of a particular size may be expected to physically “wear” after a certain number of write/erase cycles. As the transistors wear, a rate of bit errors in stored data may increase. In this case, the frequency F may be increased to compensate for device components expected to exhibit high wear, and the frequency F may be decreased to compensate for device components expected to exhibit low wear.

Alternatively or in addition, the frequency F and/or the storage size S may be selected based on the system throughput T to be achieved at the data storage device 102. To illustrate, the data storage device 102 may operate in accordance with certain design criteria, such as a particular read speed at which data is to be read from the nonvolatile memory 132 and returned to the host device 106. To achieve such design criteria, ECC codewords may be decoded by the data storage device 102 at a certain rate (i.e., a rate corresponding to an expected system throughput T). The frequency F and/or the storage size S may be selected based on the system throughput T. For example, for a higher system throughput T, the storage size S may be increased and/or the clock frequency F may be increased (e.g., to facilitate an increased read speed by decoding more ECC codewords at a faster rate). As another example, for a lower system throughput T, the storage size S may be decreased and/or the clock frequency F may be decreased (e.g., to reduce device size and/or power consumption at the data storage device 102).

In a particular embodiment, the decoder scheduler 110 is configured to manage one or more decoding operations at the controller 104. In a particular embodiment, the decoder scheduler 110 is configured to generate error distribution data 114 indicating distributions of errors in data stored at the nonvolatile memory 132. For example, if accessing the data 136 from the block 134 results in a high number of errors (e.g., a number of decoding attempts that satisfies a threshold number of decoding attempts), the error distribution data 114 may indicate that an address corresponding to the block 134 (or a portion of the block 134, such as a word line) is associated with a high error rate. In some cases, a high error rate may result from a number of write/erase cycles, which may cause physical degradation at the nonvolatile memory 132. Alternatively or in addition, a high error rate may result from one or more process defects associated with the nonvolatile memory 132. To further illustrate, if the block 138 is associated with a low error rate, then the error distribution data 114 may indicate that the block 138 (or a portion of the block 138, such as a word line) is associated with a low error rate.

The decoder scheduler 110 may selectively instruct the decoders 118, 128 to decode data based on the error distribution data 114. To illustrate, if the error distribution data 114 indicates that an address associated with the data 136 is associated with a high error rate, then the decoder scheduler 110 may “bypass” the decoder 118 in response to a data access to the data 136. For example, the decoder scheduler 110 may instruct the decoder 128 to access the set of bits 122 and the set of bits 124 from the buffer 120 to initiate a decoding operation. Alternatively or in addition, the decoder scheduler 110 may selectively instruct the decoder 118 not to access either or both of the set of bits 122 and the set of bits 124 from the buffer 120 in order to “bypass” the decoder 118. If the error distribution data 114 indicates that an address is not associated with a high error rate, then the decoder scheduler 110 may instruct the decoder 118 to perform one or more decoding operations in response to a data access to the address. In a particular embodiment, the buffer 120 includes a number of sectors (e.g., 32 sectors, or another number of sectors) each having a respective numerical identifier. Each of the sectors may be configured to store a set of bits (e.g., an ECC codeword). The decoder scheduler 110 may be configured to selectively instruct the decoders 118, 128 to access and/or to not access particular sectors of the buffer 120 using the numerical identifiers. The number of sectors corresponds to the storage size S.

Selecting the frequency F and/or the storage size S based on the expected error distribution D of ECC codewords accessed from the nonvolatile memory 132 and/or based on the system throughput T to be achieved at the data storage device 102 improves power management and processing efficiency of the data storage device 102. For example, a device that utilizes a “low cost” decoder to decode data may consume a small amount of power, but the device may have limited error correction capability. A device that utilizes a “high resolution” decoder to decode data may have increased error correction capabilities, but the high resolution decoder may result in increased power consumption. The techniques described with reference to FIG. 1 may enable the performance of a high resolution decoder while facilitating the power efficiency of a low cost decoder, resulting in improved power management and processing efficiency.

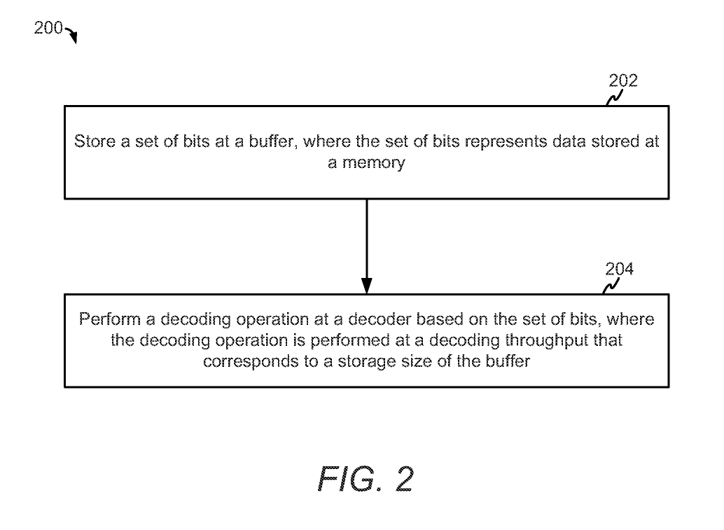

Referring to FIG. 2, a particular illustrative embodiment of a method is depicted and generally designated 200. The method 200 may be performed in the data storage device 102, such as by the controller 104.

The method 200 may include storing a set of bits at a buffer, at 202. The set of bits represents data stored at a memory. For example, the set of bits may correspond to the set of bits 124, and the data may correspond to the data 136. The buffer may correspond to the buffer 120, and the memory may correspond to the nonvolatile memory 132.

The method 200 may further include performing a decoding operation at a decoder based on the set of bits, at 204. The decoder may correspond to the decoder 128. The decoding operation may include using the set of bits 124 to decode the set of bits 122.

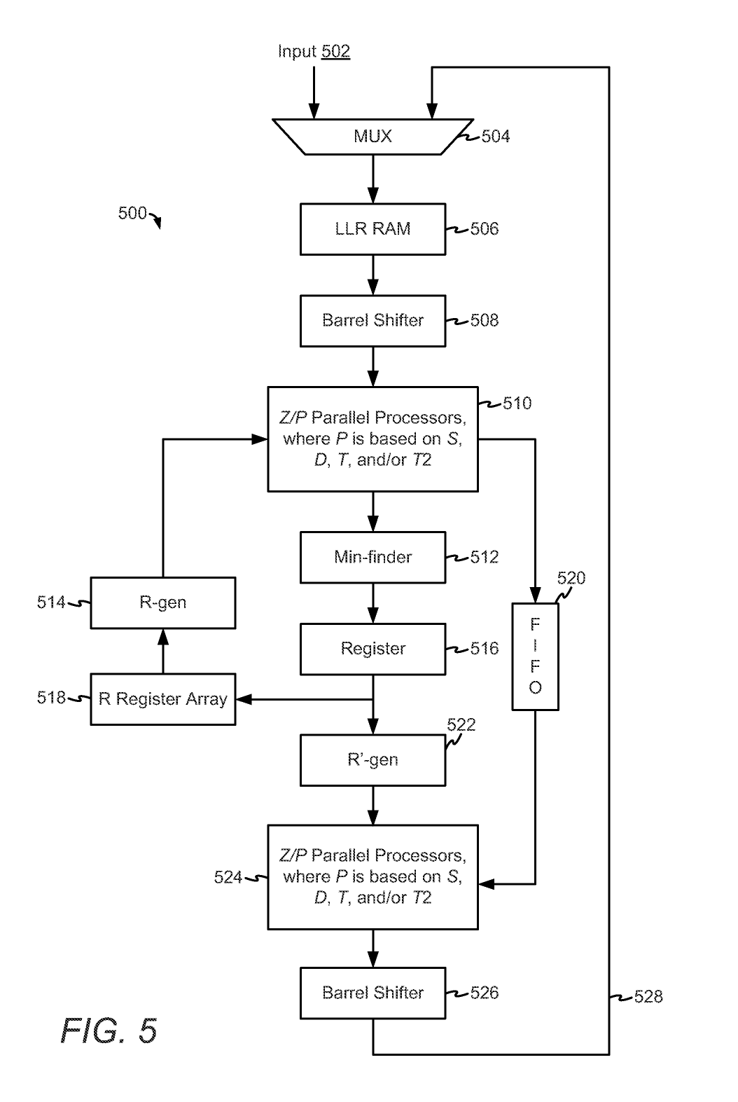

The decoding operation may be performed at the decoding throughput T1. The decoding throughput T1 may correspond to a storage size of the buffer. To illustrate, the decoder 128 may perform the decoding operation based on the frequency F of the clock signal 130. The frequency F may be selected based on the storage size S of the buffer 120. Alternatively or in addition, the decoding throughput T1 may be determined based on a number of parallel processors of the decoder 128, as described further with reference to FIG. 5.

The method 200 may improve power management at a data storage device. For example, if the decoding throughput T1 corresponds to the storage size S of the buffer, the decoding throughput T1 is neither too great (which could result in excessive power consumption) nor too low (which could result in overflow at the buffer). The method 200 therefore may improve device performance as compared to a device that operates a decoder at a “highest” (or “capacity”) rate irrespective of a size of a buffer that buffers data to be decoded.

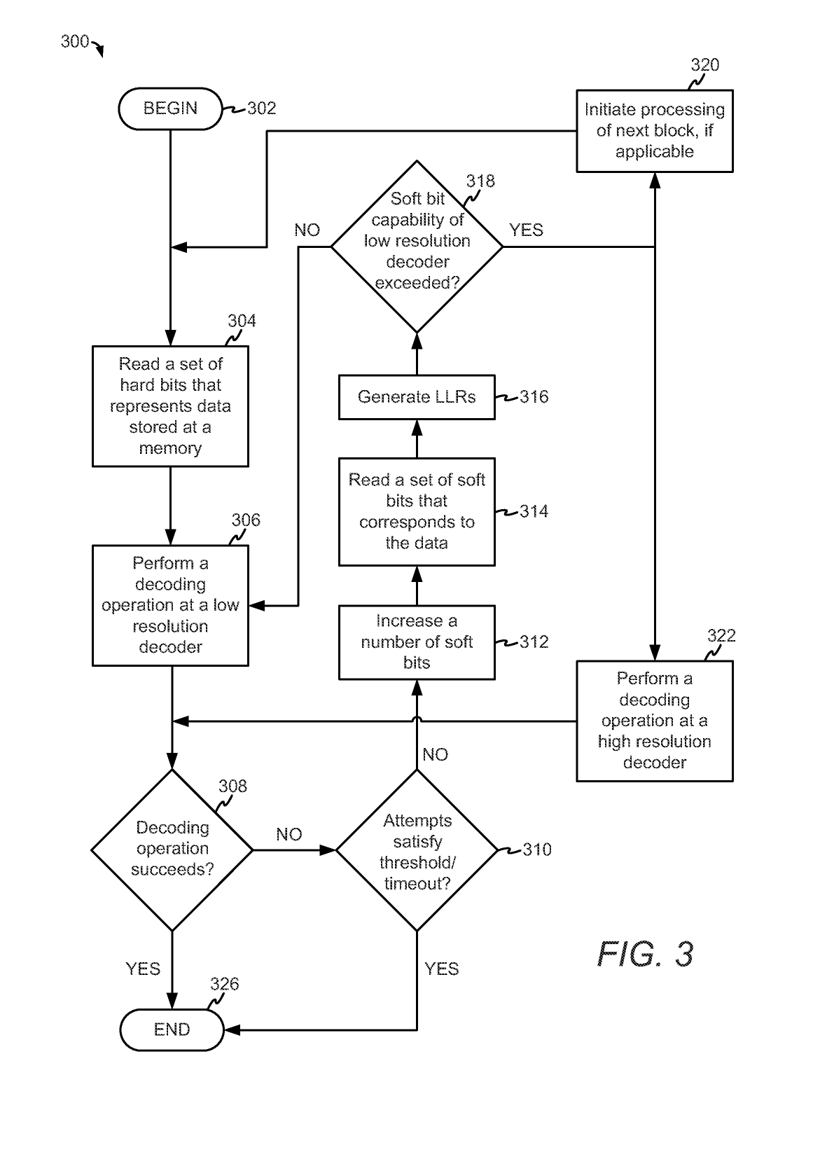

Referring to FIG. 3, a particular illustrative embodiment of a method is depicted and generally designated 300. The method 300 may be performed in the data storage device 102, such as by the controller 104.

The method 300 may be initiated, at 302, such as in response to the data storage device 102 receiving a request for read access for the data 136 from the host device 106. In a particular embodiment, initiating the method 300, at 302, may include initializing a soft bit counter (e.g., to zero), as explained further below.

The method 300 may further include reading a set of hard bits that represent data stored at a memory, at 304. The set of hard bits may correspond to the set of bits 122, and the data may correspond to the data 136. The memory may correspond to the nonvolatile memory 132.

The method 300 may further include performing a decoding operation at a low resolution decoder, at 306. The low resolution decoder may correspond to the decoder 118. The decoding operation may include attempting to reach a hard decoding decision at the decoder 118 based on the set of bits 122.

The method 300 may further include determining whether the decoding operation succeeds, at 308. If the decoding operation succeeds, the method 300 may terminate, at 326. If the decoding operation fails, then the method 300 may further include determining whether a number of decoding attempts satisfies a threshold number of decoding attempts and/or whether a time duration for the decoding attempts is expired, at 310. To illustrate, decoding may be attempted until the number of decoding attempts satisfies the threshold number of decoding attempts or until the time duration for the decoding attempts expires. If either the number of decoding attempts satisfies the threshold number of decoding attempts or the time duration for the decoding attempts expires, the method 300 may terminate, at 326. A determination may be made that an uncorrectable error correcting code (UECC) event has occurred. In this case, the controller 104 may send a message to the host device 106 indicating that the data 136 is unavailable.

If neither the number of decoding attempts satisfies the threshold number of decoding attempts nor the time duration for the decoding attempts is expired, the method 300 may further include increasing a number of soft bits, at 312. For example, if the soft bit counter is initialized to zero, the soft bit counter may be incremented to one to indicate that a first number of soft bits is to be used to decode the data. If the soft bit counter is incremented to two, then a second number of soft bits may be generated, where the second number is greater than the first number.

The method 300 may further include reading a set of soft bits that corresponds to the data, at 314. The soft bits may correspond to the set of bits 124. As a particular example, the set of soft bits may include a number of soft bits that corresponds to the first number that is determined at 312.

The method 300 may further include generating log-likelihood ratios (LLRs) based on the soft bits, at 316. For example, for a particular soft bit, an LLR may correspond to the logarithm of a likelihood that the soft bit represents a “0” bit divided by a likelihood that the soft bit represents a “1” bit.

The method 300 may further include determining whether a soft bit capability of the low resolution decoder is exceeded, at 318. To illustrate, in the example of FIG. 3, the low resolution decoder is configured to accept a certain number of soft bits (e.g., one soft bit for each hard bit, two soft bits for each hard bit, or another number of soft bits for each hard bit). In a particular embodiment, if the number indicated by the soft bit counter is within the soft bit capability of the low resolution decoder, then the soft bit capability of the low resolution decoder is not exceeded.

If the soft bit capability of the low resolution decoder is not exceeded, the method 300 may further include performing a decoding operation at the low resolution decoder, at 306, such as by re-attempting to decode the set of hard bits using the set of soft bits. If the soft bit capability of the low resolution decoder is exceeded, the method 300 may further include performing a decoding operation at a high resolution decoder, at 322, and initiating processing of a next block (if another block is to be processed), at 320. The high resolution decoder may correspond to the decoder 128. The decoding operation may include attempting to reach a “soft” decoding decision using the set of soft bits, the set of hard bits, and/or the LLRs.

The method 300 may further include determining whether the decoding operation succeeds, at 308. If the decoding operation succeeds, the method 300 may terminate, at 326. If the decoding operation fails, then the method 300 may further include determining whether the number of decoding attempts satisfies the threshold number of decoding attempts and/or whether the time duration for the decoding attempts has expired, at 310. To illustrate, decoding may be attempted until the number of decoding attempts satisfies the threshold number of decoding attempts or until the time duration for the decoding attempts expires. If either the number of decoding attempts satisfies the threshold number of decoding attempts or the time duration for the decoding attempts has expired, the method 300 may terminate, at 326. A determination may be made that an uncorrectable error correcting code (UECC) event has occurred, and the controller 104 may send a message to the host device 106 indicating that the data 136 is unavailable.

The method 300 enables decoding performance that is based on the expected error distribution D of ECC codewords at the nonvolatile memory 132 and/or that is based on the system throughput T to be achieved at the data storage device 102. For example, the threshold number of decoding attempts and/or the time duration for the decoding attempts may be selected based on the expected error distribution D of ECC codewords at the nonvolatile memory 132 and/or based on the system throughput T to be achieved at the data storage device 102. Selecting the threshold number of decoding attempts and/or the time duration for the decoding attempts in such a manner may prevent (or reduce) overflow at the buffer 120 (e.g., by causing decoding to “timeout” prior to overflow occurring at the buffer 120) while also providing increased error correction capability (e.g., by performing one or more decoding operations at the high resolution decoder when a soft bit capability of the low resolution decoder is exceeded).

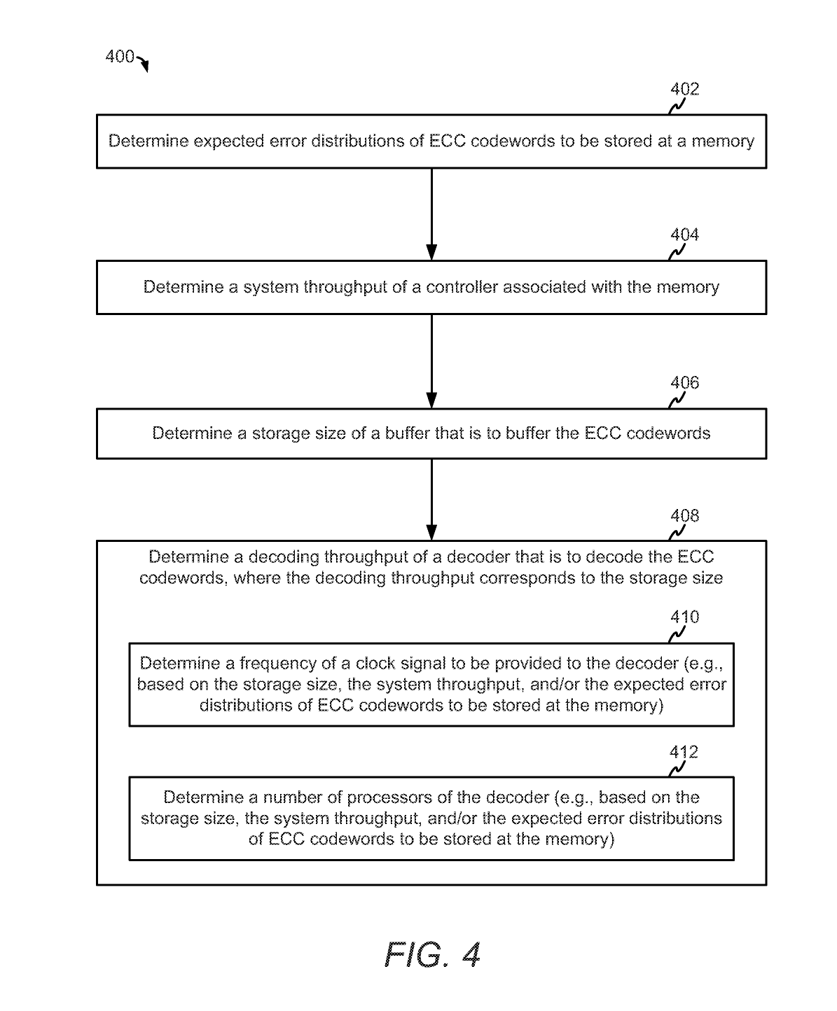

Referring to FIG. 4, a particular illustrative embodiment of a method of determining a decoding throughput of a decoder is depicted and generally designated 400. The decoder may correspond to the decoder 128. The method 400 may be performed at a computer that analyzes data that represents parameters of a device. For example, the computer may access one or more electronic design automation (EDA) files during production (e.g., design, fabrication, testing etc.) of the data storage device 102.

The method 400 may include determining expected error distributions of error correcting code (ECC) codewords to be stored at a memory, at 402. The memory may correspond to the nonvolatile memory 132. The expected error distributions may be determined using one or more techniques described with reference to FIG. 1, such as using a Gaussian distribution associated with a particular configuration of the data storage device 102.

The method 400 may further include determining a system throughput of a controller associated with the memory, at 404. The controller may correspond to the controller 104. The system throughput may be determined based on a design specification associated with the data storage device 102. For example, if the data storage device 102 is to perform read operations at a particular read rate, then the data storage device 102 may support a particular system throughput T to enable the read rate.

The method 400 may further include determining a storage size of a buffer that is to buffer the ECC codewords, at 406. The buffer may correspond to the buffer 120, and the storage size may correspond to the storage size S. The storage size S may be determined based on a design specification associated with the data storage device 102. For example, the design specification may indicate that a particular circuit area is available for the buffer 120, resulting in a particular storage size S. Alternatively, the storage size S may be determined based on the expected error distribution D (e.g., by increasing the storage size S based on a particular error distribution D) and/or based on the system throughput T (e.g., by increasing the storage size to support a high system throughput T).

The method 400 may further include determining a decoding throughput of a decoder that is to decode the ECC codewords, at 408. The decoding throughput of the decoder may correspond to the decoding throughput T1. The decoding throughput T1 may correspond to the storage size S of the buffer 120. The decoder may correspond to the decoder 128.

As an example, determining the decoding throughput T1 may include determining a frequency of a clock signal to be provided to the decoder, at 410. The clock signal may correspond to the clock signal 130, and the frequency may correspond to the frequency F. The frequency F of the clock signal 130 may be selected based on the storage size S of the buffer 120, such as by selecting the frequency F such that overflow does not occur at the buffer 120 and such that excessive power is not consumed at the decoder 128.

As another example, determining the decoding throughput T1 may include determining a number of processors of the decoder, at 412. For example, the frequency of the clock signal may be held “constant” and the number of parallel processors of the decoder may be selected to achieve the decoding throughput T1. In a particular embodiment, the number of parallel processors of the decoder is selected based on a parameter P that is determined based on the storage size S, the system throughput T, and the expected error distribution D, as explained further with reference to FIG. 5.

FIG. 5 illustrates a particular illustrative embodiment of a decoder 500 for LDPC codes. In a particular embodiment, the decoder 500 may be implemented within the data storage device 102, such as within the decoder 128. In FIG. 5, the decoding throughput T1 is achieved by selecting a number Z/P of parallel processors of the decoder 500. The number Z/P of parallel processors may be selected instead of selecting the frequency F of the clock signal 130 as described with reference to FIG. 1 (e.g., the decoder 500 may be clocked at a “normal” or non-reduced clock signal frequency). In a particular embodiment, the decoder 500 corresponds to a reduced-throughput decoder having a particular decoding throughput T1 that is reduced based on a throughput reduction factor indicated by the parameter P.

In the example of FIG. 5, the decoder 500 includes a multiplexer (MUX) 504 that is responsive to an input 502 (e.g., a set of soft bits). The decoder 500 further includes a log-likelihood ratio (LLR) random access memory (RAM) 506, a barrel shifter 508, and a set of parallel processors 510. The set of parallel processors 510 is coupled to a “minimum” finder (min-finder) 512 and to a first-in, first-out (FIFO) buffer 520 (e.g., a buffer RAM). The set of parallel processors 510 is responsive to a check message generator (“R-gen”) 514.

The decoder 500 may further include one or more registers, such as a register 516 (e.g., a “temporary” register). The register 516 is responsive to the min-finder 512. The decoder 500 may further include a register array 518, a check message generator (“R′-gen”) 522, and a set of parallel processors 524. The set of parallel processors 524 is responsive to the FIFO buffer 520 and to the check message generator 522. The decoder 500 further includes a barrel shifter 526 that is responsive to the set of parallel processors 524. The barrel shifter 526 is coupled to the MUX 504 (e.g., via a feedback path 528). The MUX 504 is configured to select between the input 502 (e.g., to initiate a decoding operation) and an output provided from the barrel shifter 526 via the feedback path 528 (e.g., to initiate a subsequent iteration of the decoding operation).

In operation, the MUX 504 may receive the input 502. The input 502 may correspond to a set of bits corresponding to data accessed from the non-volatile memory 132. The set of bits may indicate LLRs determined by the controller 104, and the LLRs may indicate likelihoods of bits corresponding to “0” and “1” values. In a particular embodiment, the input 502 includes the set of bits 124. The decoder 500 may initiate a decoding operation in response to receiving the input 502. The decoder 500 may initiate the decoding operation further in response to a command received from the decoder scheduler 110 of FIG. 1.

The LLRs indicated by the input 502 may be stored at the LLR RAM 506. The LLRs may be provided to the barrel shifter 508. The barrel shifter 508 may shift the LLRs and provide the shifted LLRs to the set of parallel processors 510. In the example of FIG. 5, the decoding throughput T1 is determined by reducing a number of processors of the set of parallel processors 510 according to the parameter P to generate a number Z/P of parallel processors. The set of parallel processors 510 may process the shifted LLRs (e.g., by performing one or more LDPC variable node checks) to generate a first set of results. The first set of results may be provided to the min-finder 512.

The min-finder 512 may be responsive to the set of parallel processors 510 to determine a “minimum” value and/or second “minimum” value associated with a message sent to an LDPC check node. The minimum value and/or second minimum value generated by the min-finder 512 may be stored at the register 516. The check message generators 514, 522 may generate check messages based on the minimum value and/or second minimum value generated by the min-finder 512.

The first set of results generated by the set of parallel processors 510 may be further provided to the FIFO buffer 520. The set of parallel processors 524 may process the first set of results (e.g., by performing one or more LDPC variable node checks) using a check message provided by the check message generator 522 to generate a second set of results. The second set of results may include updated LLRs corresponding to the input 502 after performing LDPC variable node and check node update operations. The barrel shifter 526 may shift the second set of results to generate a shifted second set of results. The feedback path 528 may provide the shifted second set of results to the MUX 504. The decoder may iterate the decoding operation until decoding convergence is achieved (e.g., until the input 502 is decoded to generate decoded data), until a number of iterations satisfies a threshold number of iterations, or until the controller 104 asserts a timeout signal at the decoder 500 (e.g., in response to initiation of a power-down event at the data storage device 102, as an illustrative example).

The example of FIG. 5 illustrates reduction of the decoding throughput T1 by reducing a number of parallel processors Z based on a decoder throughput reduction factor indicated by the parameter P. In FIG. 5, the parameter P is determined based on one or more of the expected error distribution D, the decoding throughput T2 of the decoder 118, the storage size S of the buffer 120, or the system throughput T. Accordingly, the decoding throughput T1 can be reduced by reducing a number of parallel processors Z based on P.

As an illustrative, non-limiting example, if the decoder 118 has an uncorrectable error correcting code (UECC) rate of approximately 10̂(−6) and if the decoding throughput 12 of the decoder 118 is approximately one percent greater than the system throughput T, the parameter P may be approximately 100. In this example, the decoding throughput T1 may be reduced by a factor of approximately 100 (i.e., to approximately one percent of the “capacity” decoding throughput). The parameter P may be determined at a computer based on design and/or statistical data, such as at the computer described with reference to FIG. 4. It will be appreciated that the described techniques enable decoding operations having the decoding performance of one decoder (e.g., a high resolution decoder, which may correspond to one or both of the decoders 128, 500) while also operating at a power efficiency of another decoder (e.g., a low resolution decoder, which may correspond to the decoder 118), resulting in improved power management and processing efficiency at the data storage device 102.

Although one or more components described herein are illustrated as block components and described in general terms, such components may include one or more microprocessors, state machines, or other circuits configured to enable the data storage device 102 (or one or more components thereof) to perform operations described herein. For example, one or more components described herein may correspond to one or more physical components, such as hardware controllers, state machines, logic circuits, one or more other structures, or a combination thereof, to enable the data storage device 102 to perform one or more operations described herein. One or more aspects of the data storage device 102 may be implemented using a microprocessor or microcontroller programmed to perform operations described herein, such as one or more operations of the methods 200, 300, and 400. Further, one or more operations described herein may be performed at the nonvolatile memory 132 (e.g., “in-memory” ECC decoding, as an illustrative example) alternatively or in addition to performing such operations at the controller 104. In a particular embodiment, the data storage device 102 includes a processor executing instructions that are stored at the nonvolatile memory 132. Alternatively or in addition, executable instructions that are executed by the processor may be stored at a separate memory location that is not part of the nonvolatile memory 132, such as at a read-only memory (ROM).

To further illustrate, the controller 104 may include a processor that is configured to execute instructions to perform certain operations (e.g., an algorithm) described herein. The instructions may include general purpose instructions, and the processor may include a general purpose execution unit operable to execute the instructions. The processor may access the instructions from the nonvolatile memory 132, a random access memory (RAM) included in the controller 104, another memory location, or a combination thereof. The processor may execute the instructions to store the set of bits 124 at the buffer 120, such as by executing an instruction that sends a read request for the data 136 to the nonvolatile memory 132 via the memory interface 126 and by executing an instruction that writes the set of bits 124 to the buffer 120. The set of bits 124 corresponds to the data 136 stored at the nonvolatile memory 132. The processor may execute the instructions to cause the decoder 128 to initiate a decoding operation, such as by executing an instruction that causes the buffer 120 to output the set of bits 124 to the decoder 128. The decoding operation may be performed by the decoder 128 at the decoding throughput T1. The decoding throughput T1 may correspond to the storage size S of the buffer 120.

In a particular embodiment, the controller 104 is configured to encode data according to a product code ECC scheme that uses BCH component codes. For example, the data 136 may correspond to a product code that is generated by the controller 104 based on component codes (e.g., algebraic codes, such as a BCH code, a Hamming code, or an RS code). The decoder 118 may be configured to algebraically decode the product code by performing hard decoding of the component codes. The product code may be a turbo product code or an LDPC product code, as illustrative examples. The decoder 128 may be configured to iteratively decode the product code using reliability information, which may correspond to the set of bits 124.

The data storage device 102 may be attached to or embedded within one or more host devices, such as within a housing of a host communication device, which may correspond to the host device 106. For example, the data storage device 102 may be integrated within a packaged apparatus such as a mobile telephone, a music player, a video player, a gaming device or console, an electronic book reader, a personal digital assistant (PDA), a computer, such as a laptop, a tablet, or a notebook computer, a portable navigation device, or other device that uses internal nonvolatile memory. However, in other embodiments, the data storage device 102 may be implemented in a portable device configured to be selectively coupled to one or more external devices, such as the host device 106.

The host device 106 may correspond to a mobile telephone, a music player, a video player, a gaming device or console, an electronic book reader, a personal digital assistant (PDA), a computer, such as a laptop, a tablet, or a notebook computer, a portable navigation device, another electronic device, or a combination thereof. The host device 106 may communicate via a host controller, which may enable the host device 106 to communicate with the data storage device 102. The host device 106 may operate in compliance with a JEDEC Solid State Technology Association industry specification, such as an embedded MultiMedia Card (eMMC) specification or a Universal Flash Storage (UFS) Host Controller Interface specification. The host device 106 may operate in compliance with one or more other specifications, such as a Secure Digital (SD) Host Controller specification as an illustrative example. Alternatively, the host device 106 may communicate with the data storage device 102 in accordance with another communication protocol.

The data storage device 102 may be configured to be coupled to the host device 106 as embedded memory, such as in connection with an embedded MultiMedia Card (eMMC®) (trademark of JEDEC Solid State Technology Association, Arlington, Va.) configuration, as an illustrative example. The data storage device 102 may correspond to an eMMC device. As another example, the data storage device 102 may correspond to a memory card, such as a Secure Digital (SD®) card, a microSD® card, a miniSD™ card (trademarks of SD-3C LLC, Wilmington, Del.), a MultiMediaCard™ (MMC™) card (trademark of JEDEC Solid State Technology Association, Arlington, Va.), or a CompactFlash® (CF) card (trademark of SanDisk Corporation, Milpitas, Calif.). The data storage device 102 may operate in compliance with a JEDEC industry specification. For example, the data storage device 102 may operate in compliance with a JEDEC eMMC specification, a JEDEC Universal Flash Storage (UFS) specification, one or more other specifications, or a combination thereof.

The nonvolatile memory 132 may include a three-dimensional (3D) memory, a flash memory (e.g., a NAND memory, a NOR memory, a single-level cell (SLC) flash memory, a multi-level cell (MLC) flash memory, a divided bit-line NOR (DINOR) memory, an AND memory, a high capacitive coupling ratio (HiCR) device, an asymmetrical contactless transistor (ACT) device, or another flash memory), an erasable programmable read-only memory (EPROM), an electrically-erasable programmable read-only memory (EEPROM), a read-only memory (ROM), a one-time programmable memory (OTP), a resistive random access memory (ReRAM), or a combination thereof. Alternatively or in addition, the nonvolatile memory 132 may include another type of memory.

The illustrations of the embodiments described herein are intended to provide a general understanding of the various embodiments. Other embodiments may be utilized and derived from the disclosure, such that structural and logical substitutions and changes may be made without departing from the scope of the disclosure. This disclosure is intended to cover any and all subsequent adaptations or variations of various embodiments. Those of skill in the art will recognize that such modifications are within the scope of the present disclosure.

The above-disclosed subject matter is to be considered illustrative, and not restrictive, and the appended claims are intended to cover all such modifications, enhancements, and other embodiments, that fall within the scope of the present disclosure. Thus, to the maximum extent allowed by law, the scope of the present invention is to be determined by the broadest permissible interpretation of the following claims and their equivalents, and shall not be restricted or limited by the foregoing detailed description.

What is claimed is:

1. A data storage device comprising:
a buffer, wherein the buffer is configured to receive a set of bits representing data stored at a memory; and
a decoder, wherein the decoder is configured to receive the set of bits from the buffer, and wherein the decoder is further configured to perform a decoding operation based on the set of bits at a decoding throughput that corresponds to a storage size of the buffer.

2. The data storage device of claim 1, wherein the decoder is further configured to receive a clock signal, and wherein the decoding throughput is determined based on a frequency of the clock signal.

3. The data storage device of claim 2, wherein the frequency of the clock signal is selected based on the storage size of the buffer.

4. The data storage device of claim 2, wherein the frequency of the clock signal is selected further based on expected error distributions of error correcting code (ECC) codewords stored at the memory.

5. The data storage device of claim 2, wherein the frequency of the clock signal is less than a capacity frequency of the decoder.

6. The data storage device of claim 1, wherein the decoding throughput is determined based on a number of processors included in the decoder, and wherein the number of processors is selected based on the storage size of the buffer.

7. The data storage device of claim 6, wherein the number of processors is selected further based on expected error distributions of error correcting code (ECC) codewords stored at the memory.

8. The data storage device of claim 1, wherein one or both of the storage size of the buffer or the decoding throughput of the decoder are selected based on one or both of expected error distributions of error correcting code (ECC) codewords stored at the memory or a system throughput to be achieved at the data storage device.

9. The data storage device of claim 1, further comprising a second decoder, wherein the second decoder is coupled to receive a second set of bits from the buffer, the second set of bits corresponding to the data.

10. The data storage device of claim 9, wherein the set of bits includes a set of soft bits that is generated using a soft data access technique, and wherein the second set of bits includes a set of hard bits that is generated using a hard data access technique.

11. The data storage device of claim 9, wherein the second decoder has one or more different characteristics than the decoder, and wherein the one or more different characteristics include one or more of a smaller circuit area than the decoder, a lower cost than the decoder, a faster decoding performance than the decoder, or a lower power consumption than the decoder.

12. The data storage device of claim 9, further comprising a decoder scheduler, wherein the decoder scheduler is configured to selectively instruct the decoder and the second decoder to access sets of bits from the buffer.

13. A method comprising:
in a data storage device that includes a buffer and a decoder, performing:
storing a set of bits at the buffer, wherein the set of bits represents data stored at a memory; and
performing a decoding operation at the decoder based on the set of bits, wherein the decoding operation is performed at a decoding throughput that corresponds to a storage size of the buffer.

14. The method of claim 13, wherein the decoder is further configured to receive a clock signal, and wherein the decoding throughput is determined based on a frequency of the clock signal.

15. The method of claim 14, wherein the frequency of the clock signal is selected based on the storage size of the buffer.

16. The method of claim 14, wherein the frequency of the clock signal is selected further based on expected error distributions of error correcting code (ECC) codewords stored at the memory.

17. The method of claim 14, wherein the frequency of the clock signal is less than a capacity frequency of the decoder.

18. The method of claim 13, wherein the decoding throughput is determined based on a number of processors included in the decoder, and wherein the number of processors is selected based on the storage size of the buffer.

19. The method of claim 18, wherein the number of processors is selected further based on expected error distributions of error correcting code (ECC) codewords stored at the memory.

20. The method of claim 13, wherein one or both of the storage size of the buffer or the decoding throughput of the decoder are selected based on one or both of expected error distributions of error correcting code (ECC) codewords stored at the memory or a system throughput to be achieved at the data storage device.
